(19) United States
(12) Patent Application Publication
(10) Pub. No.: US 2006/0080290 A1
(43) Pub. Date: Apr. 13, 2006

(54) Extension for lexer algorithms to handle unicode efficiently

(75) Inventor: Vincenzo Lombardi, Redmond, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 10/963,459

(22) Filed: Oct. 12, 2004

(51) Int. Cl. G06F 17/30

(52) U.S. Cl. 707/3

(57) ABSTRACT

Lexical groups are created using lexer state transitions associated with a character set. Characters that cause the lexer to transition to the same state, regardless of the current state, are put in the same group. The state transition table is then created with row entries corresponding to lexical groups instead of single characters. The resulting state transition table can be searched much faster, and takes up much less space then the prior art state transition tables. This results in faster and less memory intensive lexer programs.

### FIELD OF THE INVENTION

This invention relates to lexical analysis. More specifically this invention relates to the extension of lexer algorithms to handle Unicode more efficiently.

### BACKGROUND OF THE INVENTION

Lexers are specialized software programs that take an input file and output tokens corresponding to the input file. Lexers are commonly used as part of modern software compilers. In the case of compilers, the lexer is a finite state machine with transitions depending on the particular syntax of the programming language interpreted by the compiler. The state transitions used by the finite state machine are stored in a table, with a row entry corresponding to each letter in the character set supported by the programming language, and a column corresponding to the current state. A lexer reads a source code file, character by character, and transitions from state to state until the lexer generates tokens. The tokens are then read and used by the compiler to generate the machine code.

FIG. 1 is a flow diagram of a prior art method of generating and extracting tokens from source code. A character from the source code is read from the input stream and placed in a buffer. The character, along with the current state, is looked up in a table to determine the next state. If the next state is a final state, then a token has been found and the characters in the buffer are output as a token and the buffer is cleared of characters. If the next state is not a final state then the current state is set to the next state and a new character is read from the input stream. The method continues until all characters are read from the input stream.

At 110, a character is read from the input stream. The input stream represents the source code file that the tokens are being extracted from. The character is then added to a character buffer. The character buffer stores all the characters that have been read from the input stream since the last token was generated. When a new token is extracted from the input stream, all characters in the buffer are deleted.

At 120, the character and the current state are used to determine the next state. A table is used to hold all the state transitions. There is a row in the table for each of the characters in the character set. In addition, there is a column for each possible state that the lexer may be in. The next state is the state listed in the cell corresponding to the row represented by the current character and the column represented by the current state.

At 130, it is determined if the next state is a final state. A final state represents the end of a token. Typically, there exists a list of all states that are final states. Thus, if the next state is in the list of final states then the next state is a final state. If the next state is a final state then the lexer moves to 140. Else, the current state is set to the next state and the lexer returns to 110 where another character from the input stream can be examined.

At 140, it has been determined that the next state is a final state. Because the lexer only transitions to a final state when a token has been found, the characters in the buffer must contain a token. Once the token is placed in an output file, where it can be used by a compiler for example, the buffer is cleared and the lexer returns to 110 where a new character is desirably taken from the input stream.

The method described above is adequate for a lexer processing files made with small character sets, such as ASCII, for example. However, when a character set that comprises a large number of characters is used, the method described above can become slow and can result in an undesirably large program size. The described problem is a result of the state table used to hold the state transitions for each character and current state. As the number of characters in the character set grow, the state table also grows. A larger state table requires a greater amount of time to traverse, as well as a greater number of bytes to store. For example, a state transition table for the ASCII character set requires only 256 rows, making the ASCII character set well suited for the method described above. In contrast, a state transition table for the Unicode character set would require 65536 rows, making a search of the resulting table much more time consuming and requiring a much larger amount of memory to store.

What are needed are systems and methods for efficiently performing lexical analysis on input files using large character sets.

### SUMMARY OF THE INVENTION

The present invention solves the problems associated with large character sets through the use of lexical groups. Lexical groups are created based on the lexer state transitions associated with the characters. Characters that cause the lexer to transition to the same state, regardless of the current state, are put in the same lexical group. The state transition table is then created with row entries corresponding to lexical groups instead of single characters. The resulting state transition table can be searched much faster, and takes up much less space than the prior art state transition tables. This results in faster and less memory intensive lexer programs.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a flow diagram of a prior art method for generating tokens from a source code;

FIG. 2 is a flow diagram of an exemplary method for generating tokens from source code utilizing lexical groups in accordance with the present invention;

FIG. 3 is a block diagram of an exemplary system for generating tokens from source code utilizing lexical groups in accordance with the present invention; and

FIG. 4 is a block diagram showing an exemplary computing environment in which aspects of the invention may be implemented.

### DETAILED DESCRIPTION OF ILLUSTRATIVE EMBODIMENTS

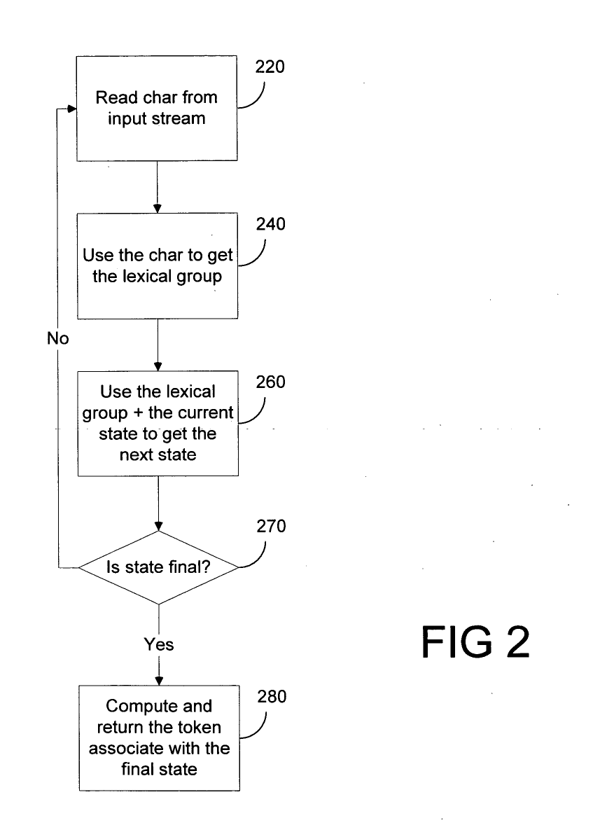

FIG. 2 is a flow diagram of an exemplary method for generating and extracting tokens from source code using lexical groups in accordance with the present invention. A character from the source code is desirably read from the input stream and placed in a buffer. The character is desirably located in a table to determine its lexical group. The lexical group, along with the current state, is desirably located in a second table to determine the next state. If the next state is a final state the characters in the buffer are desirably output as part of a token associated with the final state and the buffer is desirably cleared of characters. If the next state is not a final state, then the current state is desirably set to the next state and a new character is desirably read from the input stream. The method desirably continues until all characters are read from the input stream. While the exemplary embodiment is described it terms of Unicode characters, it is for example only, and not meant to limit the invention to the Unicode character set. The invention is equally applicable for use with characters of any type.

At 220, a Unicode character is desirably read from the input stream. The input stream desirably comprises a source code file or some file that the user desires to convert into tokens. Any method, system, or technique known in the art for reading characters from an input stream can be used.

Once read, the character is desirably stored in a variable called current character, for example. The variable is desirably two bytes in size to accommodate the size of the Unicode character. After reading the character from the input stream, the embodiment desirably proceeds to 240.

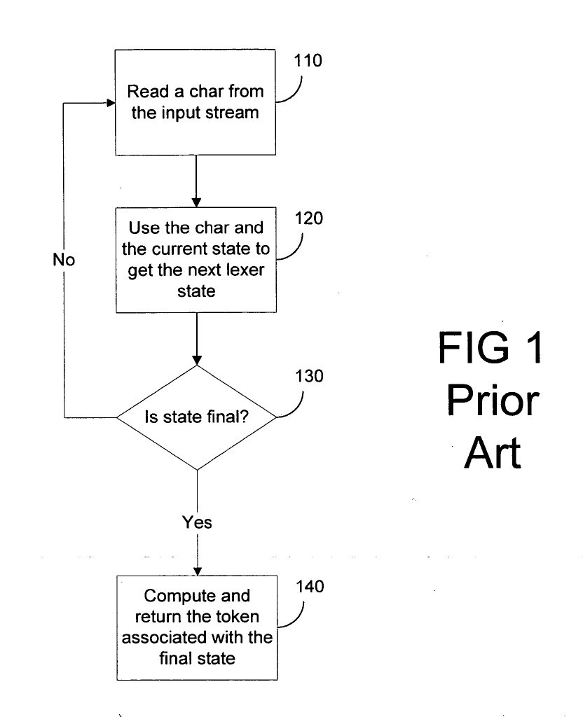

At 240, the lexical group corresponding to the current character is desirably retrieved. An advantage of the Unicode character set versus the ASCII character set is that the Unicode character set features a much greater number of characters. While advantageous, this also makes designing a lexical analyzer much more difficult. As shown in FIG. 1, each character and current state was desirably looked up in a table, the table comprising a cell for each character and state pair, to find the next state transition for the lexical analyzer. This process desirably continued until a final state was reached indicating a token. Because the number of possible characters did not exceed 256, looking up the character and state pairs in the table was manageable. In contrast, using the same method as described in FIG. 1 for Unicode characters would require a table with 65536 rows, making the size of the code much larger, and dramatically increasing the time required to search and retrieve the data from the table.

To reduce the size of the resulting Unicode table, lexical groups are desirably used to generate the state table instead of Unicode characters. While Unicode supports 65536 characters, there are certain characters that, because of the programming language that the input stream is written in, result in the same state transition for the purposes of generating tokens. In general, the lexical groups desirably comprise one group for the Unicode characters that represent letters; one group for Unicode characters that represent non-letters that are valid in an identifier, such as ‘_’, for example; and a separate group for each Unicode character that does not fit into either of the two categories. While the present embodiment is described with respect to the previously mentioned Unicode categories, it is not meant to limit the invention to the categories specified. Depending on the underlying programming language that the input stream is written in, there may be more or fewer possible Unicode categories.

As described above, one possible lexical group is all Unicode characters that represent letters. For example, when a character in the input stream is a letter, all of the possible state transitions based on the current state and that character are the same regardless of the value of the letter. This is a result of how the underlying programming language treats letters. In the C programming language, for example, a valid identifier is a string of characters that must start with either a letter or an ‘_’. An identifier is a variable name defined in a C program. Therefore, for the purposes of the lexer recognizing and parsing identifiers, the lexer can desirably treat all letter Unicode characters the same. Instead of creating a row for each possible Unicode character that represents a letter, a single row in the table is desirably created for all letter characters regardless of their value.

Similarly, in the C programming language definition of an identifier, except for the first character, which must be a letter or an ‘_’, the rest of the characters in the identifier do not have to be letters, but can be numbers or other non-letter characters. Therefore, for the purposes of the lexer recognizing and parsing identifiers, the lexer can desirably treat all non-letters that are valid in an identifier Unicode characters the same. Instead of creating a single row in the table for each non-letters that is valid in an identifier character, a single row is desirably created for all non-letter that are valid in an identifier characters.

Moreover, all Unicode characters that do not fit in either of the previously described lexical groups are desirably assigned their own lexical group. As described above, the chosen lexical groups are based on the underlying programming language used to generate the input file. While an embodiment is described with respect to the C programming language, the invention is applicable to any programming language known in the art. As shown, the lexical groups are generated based on the specification of the particular programming language, and can be easily modified for a given programming language by adapting the lexical groups to fit the specification of the particular programming language.

Given the lexical groups as described above, the lexical group associated with the current character is desirably retrieved. In addition, the current character is desirably added to a buffer containing all of the characters retrieved from the input stream prior to the last token being generated. While the lexical group of the current character is desirably used to retrieve the next state of the lexer, the generated token desirably contains the actual characters retrieved from the input stream.

When the lexical group has been determined, and the current character is written to the buffer, the embodiment desirably continues to 260.

At 260, the next state is desirably determined. As described above, the next state is determined by finding the state transition located in the cell found at the row representing the lexical group, and the column corresponding to the current state of the lexer. The table represents a finite state machine for processing tokens by the lexer. The table is desirably generated using the specifications of programming language used to generate the input stream. After determining the next state from the table, the current state is desirably set to the next state, and the embodiment desirably proceeds to 270.

At 270, the embodiment determines if the current state is a final state. As described above, for the purposes of the lexer program, a state is final when it indicates that a token can be generated. There may be several types of final states, each final state indicating a different type of token. The states that qualify as final, as well as the corresponding token type, are desirably determined by the specification of the programming language used to generate the input stream. Whether a state is final or not can be determined by comparing the current state against a list of final states. If the current state is a final state then the embodiment desirably continues at 280 where the token is generated. Else, the embodiment returns to 220 where the next character from the input stream is desirably read.

At 280, the embodiment has desirably determined that a final state has been reached, and desirably generates the token associated with the final state. As described above, the lexical group associated with the current character was desirably used to determine the next state of the lexer program. However, the current character, as well as each of the characters read from the input stream prior to the last token being generated, was desirably stored in a buffer. The embodiment, using the particular final state of the lexer program, and the characters in the buffer, desirably generates the token associated with the final state. Any system, method or technique known in the art for generating a token from characters and a final state can be used. Once the token has been generated, the embodiment desirably clears the buffer of characters, resets the current state to some beginning or first state, and if desired, continues to generate tokens from the input stream.

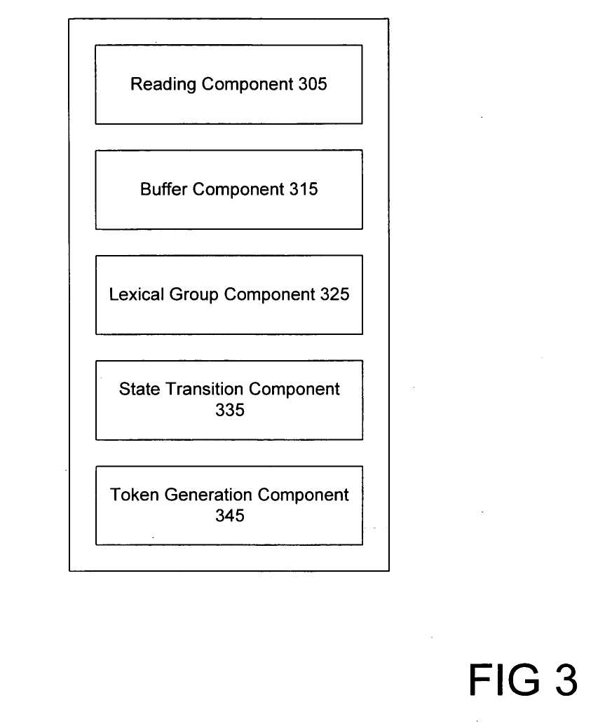

FIG. 3 is a block diagram of an exemplary system for lexical analysis using lexical groups in accordance with the present invention. The system desirably comprises a reading component 305, a buffer component 315, a lexical group component 325, a state transition component 335, and a token generation component 345.

The reading component 305 is desirably used to read characters from an input file. As described with respect to FIG. 2, characters are desirably read from the input file one at a time. The characters are desirably from the Unicode character set, however any character set known in the art can be used. The input file desirably comprises source code written in a programming language such a C, for example. The reading component 305 can be implemented using any suitable system, method or technique known in the art for reading characters from an input file. The reading component 305 can be implemented using software, hardware, or a combination of both.

The buffer component 315 is desirably used to store read characters from the reading component 305. As described in FIG. 2, while lexical groups are desirably used to determine the next state transition instead of the character from the input file, the actual characters read from the input file are desirably used to generate the resulting token once a final state transition in encountered. Accordingly, after reading a character from the input file by the reading component 305, the character is desirably sent to the buffer component 315 where it is added to a character buffer. The buffer component 315 desirably stores read characters until a token is generated, and after which the buffer component 315 desirably clears all read characters from the buffer. The buffer component 315 can be implemented using any suitable system, method or technique known in the art for storing read characters. The buffer component 315 can be implemented using software, hardware, or a combination of both.

The lexical group component 325 is desirably used to generate the lexical groups, and determine what lexical group a character belongs to. As described with respect to FIG. 2, to simplify the state transition table, each character in the character set is desirably assigned a lexical group. Lexical groups are generated based on the semantic properties of the programming language used to generate the input file. Each character in a lexical group has the property that given the same current state, that character will cause the same next state transition for the lexer. The lexical group component 325 desirably stores each character in the character set along with the character's lexical group. Once a character has been read from the input stream and stored in the character buffer, the character is desirably used by the lexical group component 325 to retrieve the associate lexical group. The lexical group component 325 can be implemented using software, hardware, or a combination of both.

The state transition component 335 is desirably used to determine the next state transition of the lexer algorithm given a current state and a lexical group. As described with respect to FIG. 2, the next state transition for the lexer algorithm is desirably determined by searching a table of next state transitions for the next state transition in the cell corresponding to the current lexer state and the lexical group, for example. The table is desirably generated using the semantics of the underlying programming language used to generate the input file. Because each programming language may have different semantics, each programming language desirably has a unique state transition table. The state transition component 335 can be implemented using any suitable system, method or technique known in the art for generating a state transition table from a programming language specification. The state transition component 335 can be implemented using software, hardware, or a combination of both.

The token generating component 345 is desirably used to generate the token associated with the final state using the characters from the character buffer. As described with respect to FIG. 2, when the next state transition state is final state, the token associated with the final state is desirably generated using the characters from the character buffer. The token is generated by the token generating component 345 from the character buffer using the semantics of the underlying programming language used to generate the input file. The tokens are desirably used by a compiler to generate machine code for execution on a computer, for example. The token generating component 345 can be implemented using any suitable system, method or technique known in the art for generating tokens from a character buffer. The token generating component 345 can be implemented using software, hardware, or a combination of both.

Exemplary Computing Environment

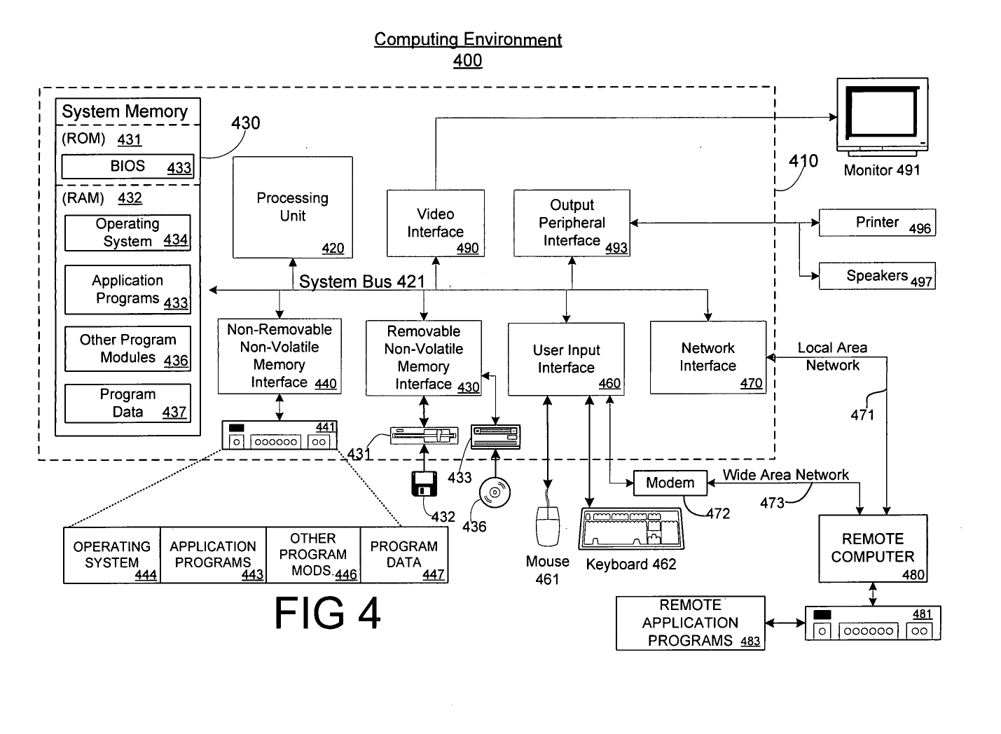

FIG. 4 illustrates an example of a suitable computing system environment 400 in which the invention may be implemented. The computing system environment 400 is only one example of a suitable computing environment and is not intended to suggest any limitation as to the scope of use or functionality of the invention. Neither should the computing environment 400 be interpreted as having any dependency or requirement relating to any one or combination of components illustrated in the exemplary operating environment 400.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 4, an exemplary system for implementing the invention includes a general purpose computing device in the form of a computer 410. Components of computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 410 typically includes a variety of computer readable media. Computer readable media can be any available media that can be accessed by computer 410 and includes both volatile and non-volatile media, removable and non-removable media. By way of example, and not limitation, computer readable media may comprise computer storage media and communication media. Computer storage media includes both volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 410. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 430 includes computer storage media in the form of volatile and/or non-volatile memory such as ROM 431 and RAM 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436, and program data 437.

The computer 410 may also include other removable/non-removable, volatile/non-volatile computer storage media. By way of example only, FIG. 4 illustrates a hard disk drive 440 that reads from or writes to non-removable, non-volatile magnetic media, a magnetic disk drive 451 that reads from or writes to a removable, non-volatile magnetic disk 452, and an optical disk drive 455 that reads from or writes to a removable, non-volatile optical disk 456, such as a CD-ROM or other optical media. Other removable/non-removable, volatile/non-volatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media provide storage of computer readable instructions, data structures, program modules and other data for the computer 410. In FIG. 4, for example, hard disk drive 441 is illustrated as storing operating system 444, application programs 445, other program modules 446, and program data 447. Note that these components can either be the same as or different from operating system 434, application programs 435, other program modules 436, and program data 437. Operating system 444, application programs 445, other program modules 446, and program data 447 are given different numbers here to illustrate that, at a minimum, they are different copies. A user may enter commands and information into the computer 410 through input devices such as a keyboard 462 and pointing device 461, commonly referred to as a mouse, trackball or touch pad. Other input devices (not shown) may include a microphone, joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. In addition to the monitor, computers may also include other peripheral output devices such as speakers 497 and printer 496, which may be connected through an output peripheral interface 495.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 4. The logical connections depicted include a LAN 471 and a WAN 473, but may also include other networks. Such networking environments are commonplace in offices, enterprise-wide computer networks, intranets and the internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the internet. The modem 472, which may be internal or external, may be connected to the system bus 421 via the user input interface 460, or other appropriate mechanism. In a networked environment, program modules depicted relative to the computer 410, or portions thereof, may be stored in the remote memory storage device. By way of example, and not limitation, FIG. 4 illustrates remote application programs 485 as residing on memory device 481. It will be appreciated that the network connections shown are exemplary and other means of establishing a communications link between the computers may be used.

As mentioned above, while exemplary embodiments of the present invention have been described in connection with various computing devices, the underlying concepts may be applied to any computing device or system.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

While the present invention has been described in connection with the preferred embodiments of the various figures, it is to be understood that other similar embodiments may be used or modifications and additions may be made to the described embodiments for performing the same function of the present invention without deviating therefrom. Therefore, the present invention should not be limited to any single embodiment, but rather should be construed in breadth and scope in accordance with the appended claims.

What is claimed:

1. A method for tokenizing an input file, comprising:
receiving a character from the input file;
determining a lexical group for the received character;
determining a next state transition for a lexer using the lexical group and a current state of the lexer; and
outputting a token if the next state transition is to a final state.

2. The method of claim 1, further comprising adding the received character to a character buffer.

3. The method of claim 2, wherein outputting a token comprises:
processing the contents of the character buffer into a token associated with the final state; and
clearing the character buffer.

4. The method of claim 1, further comprising transitioning to the next state if the next state transition is not to a final state.

5. The method of claim 1, wherein the input file comprises source code.

6. The method of claim 1, wherein the character is a Unicode character.

7. The method of claim 1, wherein determining the lexical group for the character comprises looking up the character in a table and returning the lexical group associated with the character.

8. The method of claim 7, wherein each character in a lexical group has the same next state lexer transition for the same current state.

9. The method of claim 7, wherein each character in a lexical group is a Unicode character.

10. The method of claim 7, wherein the lexical group comprises only letter Unicode characters.

11. The method of claim 7, wherein the input file comprises source code written in a programming language, the programming language comprising identifiers, wherein the lexical group comprises only non-letter characters that are valid in an identifier.

12. The method of claim 1, wherein determining a next state transition for the lexer using the lexical group and a current state of the lexer comprises:
looking up the lexical group and the current state in a table; and
returning the next state transition associated with the lexical group and current state in the table.

13. A system for tokenizing an input file by a lexer, the system comprising:
a reading component for reading a character from an input file;
a buffer component for storing the read character, and previously read characters, if any in a character buffer;
a lexical group component for generating a lexical group from the read character;
a state component for determining a next state transition from the lexical group and a current state; and
a token generating component for generating a token from the characters in the character buffer if the next state transition is a final state.

14. The system of claim 13, wherein the input file is a source code file.

15. The system of claim 13, wherein the characters comprise Unicode characters.

16. The system of claim 13, wherein the lexical group component comprises a component identifying the lexical group the character belongs to, wherein each character in the lexical group has the same next state transition for the same current state.

17. The system of claim 16, wherein component identifying the lexical group the character belongs to comprises locating the character in a table and returning the associated lexical group.

18. The system of claim 17, wherein the table is generated based on a programming language syntax.

19. The system of claim 14, wherein the state component locates the lexical group and the current state in a table, and returns the associated next state transition.

20. The system of claim 19, wherein the table is generated based on a programming language syntax.

21. The system of claim 14, further comprising the buffer component clearing the character buffer if the next state transition is a final state.

22. A method for generating lexical groups for a programming language from a set of characters, comprising:
creating a first lexical group corresponding to the set of characters that are letters; and
identifying characters that are valid in identifiers in the programming language, and creating a second lexical group corresponding to non-letter characters that are valid in identifiers.

23. The method of claim 22, further comprising creating lexical groups corresponding to all characters not in the first lexical group or the second lexical group.

24. A computer-readable medium with computer-executable instructions stored thereon for performing the steps of:
receiving a character from an input file;
determining a lexical group for the received character;
determining a next state transition for the lexer using the lexical group and a current state of the lexer; and
outputting a token if the next state transition is to a final state.

25. The computer-readable medium of claim 24, further comprising computer-executable instructions for adding the received character to a character buffer.

26. The computer-readable medium of claim 25, wherein outputting a token comprises computer-executable instructions for:
processing the contents of the character buffer into a token associated with the final state; and
clearing the character buffer.

27. The computer-readable medium of claim 24, further comprising computer-executable instructions for transitioning to the next state if the next state transition is not to a final state.

28. The computer-readable medium of claim 24, wherein the input file comprises source code.

29. The computer-readable medium of claim 24, wherein the character is a Unicode character.

30. The computer-readable medium of claim 24, wherein determining the lexical group for the character comprises looking up the character in a table and returning the lexical group associated with the character.

31. The computer-readable medium of claim 30, wherein each character in a lexical group has the same next state lexer transition for the same current state.

32. The computer-readable medium of claim 30, wherein each character in a lexical group is a Unicode character.

33. The computer-readable medium of claim 30, wherein the lexical group comprises only letter Unicode characters.

34. The computer-readable medium of claim 30, wherein the input file comprises source code written in a programming language, the programming language comprising identifiers, wherein the lexical group comprises only non-letter characters that are valid in an identifier.

35. The computer-readable medium of claim 24, wherein determining a next state transition for the lexer using the lexical group and a current state of the lexer comprises computer-executable instructions for:
looking up the lexical group and the current state in a table; and
returning the next state transition associated with the lexical group and current state in the table.
